(19) United States
(12) Patent Application Publication
(10) Pub. No.: US 2002/0089689 A1
(43) Pub. Date: Jul. 11, 2002

(54) Methods and systems for print system component-generated job separator pages

(75) Inventors: Andrew Rodney Ferlitsch, Tigard, OR (US); Tsuyoshi Nagao, Vancouver, WA (US); Thomas William Prill, Vancouver, WA (US)

Correspondence Address: SHARP LABORATORIES OF AMERICA, 5750 NW PACIFIC RIM BLVD, CAMAS, WA, 98607, US

(73) Assignee: Sharp Laboratories of America, Inc., Camas, WA

(21) Appl. No.: 09/683,162

(22) Filed: Nov. 27, 2001

Related U.S. Application Data
(63) Continuation-in-part of application No. 09/681,409, filed on Mar. 30, 2001.
Application No. 09/681,409 is a continuation-in-part of application No. 09/681,208, filed on Feb. 22, 2001.
(63) Continuation-in-part of application No. 09/681,416, filed on Mar. 30, 2001.
Application No. 09/681,416 is a continuation-in-part of application No. 09/681,208, filed on Feb. 22, 2001.
(60) Provisional application No. 60/261,132, filed on Jan. 11, 2001.
(60) Provisional application No. 60/261,132, filed on Jan. 11, 2001.

(51) Int. Cl. G06F 3/12; G06F 15/00; G06F 12/00; G06K 15/02

(52) U.S. Cl. 358/1.15; 358/1.16

(57) ABSTRACT

Embodiments of the present invention comprise methods and systems for combining a print job characteristic description with a print job. In some embodiments, a print job separator page is combined with a print job thereby forming a single combined print job.

### CROSS REFERENCE TO RELATED APPLICATIONS

This application claims the benefit of Provisional Application Serial No. 60/261,132, entitled “Methods and Systems for Print-Processor Modified Printing” filed Jan. 11, 2001 by inventors Ferlitsch et al; this application also claims the benefit of U.S. patent application Ser. No. 09/681,208, entitled “Methods and Systems for Print-Processor Modified Printing” filed Feb. 22, 2001 by inventors Ferlitsch et al; this application also claims the benefit of U.S. patent application Ser. No. 09/681,409, entitled “Methods and Systems for Print-Processor-Based Printer Status Detection and Print Task Distribution” filed Mar. 30, 2001 by inventors Ferlitsch et al; this application further claims the benefit of U.S. patent application Ser. No. 09/894,928, entitled “Methods and Systems for Page-independent Spool File Sheet Assembly” filed Jun. 28, 2001 by inventor Ferlitsch; this application further claims the benefit of U.S. patent application Ser. No. 09/681,41 6, entitled “Methods and Systems for Print-Processor-Based Print Task Error Recovery” filed Mar. 30, 2001 by inventors Ferlitsch et al.

### BACKGROUND OF INVENTION

Print job separator pages or banner pages are often used to identify and separate print jobs. They are especially useful on high-volume network printers that print jobs originating from multiple clients. Print job separator pages may identify the origin of the print job or its characteristics. They also preserve privacy by allowing identification of the job without inspection of its contents.

In order to function optimally, job separator pages must be printed at the beginning of a print job with the same face-up or face-down configuration as the print job.

Known separator page methods typically generate a separator page as a distinct print job that is despooled prior to the accompanying print job. In some known systems, a print processor despools a banner or separator page prior to despooling the print job. However, this use of a separate print job isolates the separator page from the accompanying print job allowing the two distinct print jobs to be isolated thereby causing misplaced separator pages in some circumstances.

For example, in a shared printing environment wherein print job interleaving is used, another print job can be interleaved between a separator page job and its associated print job.

In a prioritizing spooler system wherein print jobs are prioritized according to their attributes rather than time-of-arrival, print jobs may be reordered and separator page print jobs may be ordered so that they are no longer adjacent to their associated print job.

On printers using a face-up output format, each job is printed face-up followed by the next job that is printed face-up on top of the prior job. In this situation, a separator page print job is typically printed face-up and the associated print job is printed face-up on top of the separator page thereby negating many of the functions of the separator page such as privacy and easy identification.

Printers with multiple output trays may also cause problems with known separator page techniques. When output trays are not closely matched between a separator page job and its associated print job, the separator page can be divorced from its print job.

### SUMMARY OF THE INVENTION

The systems and methods of embodiments of the present invention allow print job separator page data to be combined with an associated print job so that the separator page cannot be divorced from its associated print job. The job separator page data and the associated print job may be combined into a single print job.

### BRIEF DESCRIPTION OF DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting a typical print job spool file and an associated combined print job of embodiments of the present invention in a printer-ready format;

FIG. 2 is a diagram depicting a typical print job spool file and an associated combined print job of embodiments of the present invention in a journaled format;

FIG. 3 is a diagram depicting a spooler-based embodiment of the present invention in a printer-ready mode system;

FIG. 4 is a diagram depicting a spooler-based embodiment of the present invention in a journaled mode system wherein a combined, journaled print job is created;

FIG. 5 is a diagram depicting a spooler-based embodiment of the present invention in a journaled mode system wherein a combined, printer-ready print job is created;

FIG. 6 is a diagram depicting a print processor-based embodiment of the present invention in a printer-ready mode system;

FIG. 7 is a diagram depicting a print processor-based embodiment of the present invention in a journaled mode system wherein a combined, journaled print job is created;

FIG. 8 is a diagram depicting a print assistant-based embodiment of the present invention in a printer-ready mode system wherein the print assistant receives a print job before a spooler;

FIG. 9 is a diagram depicting a print assistant-based embodiment of the present invention in a printer-ready mode system wherein the print assistant receives a print job between a spooler and a print processor;

FIG. 10 is a diagram depicting a print assistant-based embodiment of the present invention in a printer-ready mode system wherein the print assistant receives a print job after a print processor;

FIG. 11 is a diagram depicting a print assistant-based embodiment of the present invention in a journaled mode system wherein the combined print job is created before conversion of the original print job to a printer-ready format; and

FIG. 12 is a diagram depicting a print assistant-based embodiment of the present invention in a journaled mode system wherein the combined print job is created after conversion of the original print job to a printer-ready format

### DETAILED DESCRIPTION

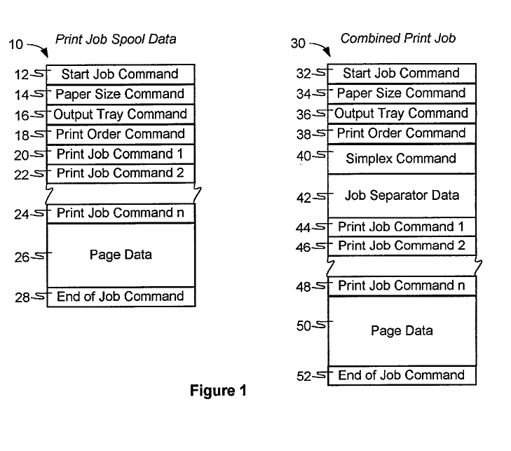

The figures listed above are expressly incorporated as part of this detailed description. It will be readily understood that the components of the present invention, as generally described and illustrated in the figures herein, could be arranged and designed in a wide variety of different configurations. Thus, the following more detailed description of the embodiments of the systems and methods of the present invention, as represented in FIGS. 1 through 8 is not intended to limit the scope of the invention, as claimed, but is merely representative of the presently preferred embodiments of the invention. Some embodiments of the present invention will be best understood by reference to the drawings, wherein like parts are designated by like numerals throughout.

The systems and methods of embodiments of the present invention typically comprise one or more printing devices, which may be connected locally, through a network or through a remote printing environment. These systems and methods may further comprise a computing device capable of generating or transmitting a print job to a printing device. These embodiments may also comprise a printer driver, a spooler, a print processor and other print system components that process, transmit or otherwise function to produce a print job. In some embodiments, these components may exist in a Microsoft Windows 9x, Me, NT, 2000, XP or similar operating system. Details of these operating system print system components and processes may be obtained by reference to the Microsoft Windows Driver Development Kits (DDKs) and associated documentation, which is hereby incorporated herein by reference.

Embodiments of the present invention which utilize a Microsoft Windows® operating system generally comprise a printer driver, spooler, print processor and other print system components which process print tasks generated through the operating system and applications running on the operating system. Embodiments used in conjunction with other operating systems will utilize similar processing elements.

Exemplary embodiments of the present invention will be described with terminology related to a Microsoft Windows® environment, however these terms shall relate to equivalent elements in other operating systems. For example, the print processor described in many embodiments will relate to a print processor common in the Windows® environment as well as elements with equivalent functions in other operating systems.

The definitions in this and subsequent paragraphs apply throughout this specification and related claims. The term “print job” may refer to any combination of data that can be printed. A print job may comprise text and/or graphics and may comprise part of a page, a single page or many pages. Print jobs may be rendered or un-rendered. Generally, a print job is generated by an application, such as a word processor, spread sheet, etc., however, a print job may also comprise a file or data in memory that may be sent directly to a print process.

The term “network” may refer to any combination of computing devices and peripherals, such as printing devices, wherein the devices can communicate with each other. The term “network” may comprise Local Area Networks (LANs), Wide Area Networks (WANS) and many other network types. A network may be connected using conventional conductive cable, fiber-optic cable, phone line cable, power line cable or other electrical and light conductors and other signal transmission media as well as wireless connections using infrared, RF or other wireless methods.

To simplify discussion of a printing system used under a Microsoft Windows operating system, some groups of system components may be referred to collectively. Some components may also be referred to generically by their group name. For example, a spooler API server may be referred to as a spooler. A group of components comprising a spooler client interface, spooler API server, router, print job creation API and job scheduling API may be referred to as a spooler in a Windows NT/2000 operating system. A group of components comprising a language monitor, port monitor and port driver stack may be referred to as a port manager. A group of components comprising a file format director and EMF print processor DLL may be referred to as a print processor. Equivalent component groups may be referred to by these terms also whether in a Microsoft operating system or another system.

References to a Microsoft Windows or Windows operating system may refer to any version or variation of a Microsoft Windows operating system comprising Windows 95, Windows 98, Windows NT, Windows 2000, Windows ME, Windows XP and others. While exemplary embodiments of the present invention may be directed to a Windows operating system and environment, systems and methods directed to other operating systems such as Macintosh, UNIX, DOS, Linux, MVS and others are to be contemplated within the scope of the present invention.

Embodiments of the present invention may be embodied in software, firmware, hardware and other forms that achieve the function described herein. As embodiments of the present invention may be adapted to many environments with varying computing devices, operating systems, printing devices, network hardware and software, applications and other variables, these embodiments may take many forms to achieve their function. Some embodiments may also be transmitted as signals, for example, and not by way of limitation, embodiments may be transmitted as analog or digital electrical signals or as light in a fiber-optic line. All of these embodiments are to be considered within the scope of the present invention.

In a typical printing environment, a user may initiate a print job, which generally comprises a single document generated by an application that is to be printed. In some embodiments of the present invention, a user may also initiate a print task, which may comprise one or more documents consisting of one or more pages each. A print task may also comprise multiple copies of a print job. A print job or task may be pre-processed into printer-ready data, such as output in a Page Description Language (PDL) such as Print Command Language (PCL), Adobe Postscript, Portable Document Format (PDF) and Tagged-Image File Format (TIFF) as non-limiting examples. A print job or task may also be journaled. In a journaled print job or task, rendering instructions are recorded for subsequent playback. Some examples of journaled formats are Enhanced Metafile (EMF) and Sharp's Printer Meta file (PMF).

Generally, when a print job or task is initiated, a user makes an input selection to initiate the process. The computing device may respond with the display of a dialog such as a print dialog box, a command line query, a panel display or some other form of user interface that allows a user to select print task options. One option may be the selection of the printing device such as a printer, plotter, Multi-Function Peripheral (MFP), CD burner or other device. Once the printing device is selected, a driver and, optionally, a print processor and other print system components may be loaded. Once the driver and/or other print system components are loaded, an additional dialog may be presented to prompt a user of options available on the selected device. Options such as print quality, paper size, orientation, tray selection, manual feed, stapling, watermarks and other options may generally be selected.

In some embodiments of the present invention, print system components may present the user with a dialog that provides print job or print task separator page options. Other embodiments may automatically select separator page options for print jobs or tasks.

Once printing options, comprising separator page options, have been selected or otherwise established, either manually or automatically, print job or task processing may commence. Print job or task processing may comprise construction of print job or print task specific information by the printer driver. This may comprise device initialization and environment data such as DEVMODE data in a Microsoft Windows environment. Rendering instructions are then compiled and either recorded for deferred playback journaled data) or processed into printer-ready data. In some cases, a print task may be partially or wholly rendered into printer-ready data in a previous step and the compilation of rendering instruction may be skipped or partially skipped.

The output from a print driver, in a spooled print environment, may be referred to as a spool file and its contents may be referred to as spool data. A spool file may be recorded on disk, in memory, in cache or other storage media compatible with a computing device. In embodiments of the present invention, a spool file may comprise interleaving data. Interleaving data may comprise printer output mode options such as, but not limited to, output tray options, output page orientation, output page location, media selection or other criteria affecting aspects of printing device output.

When the spool file is complete, control is passed from the driver to another print system component. In some systems, control is passed to a print processor, which may determine whether the data is in a printer-ready format and process the data accordingly. If the data is in a printer-ready format, it may be sent to the port of the selected printing device. If the data is journaled, it may be further processed into a printer-ready format. This process may be referred to as spooling as the data is spooled from the spool file to its destination. Once journaled data is processed into printer-ready data, it may be despooled to the port associated with its destination printing device.

In some embodiments of the present invention, a job separator page may be combined with a print job through the use of a print system component such as a spooler. In these spooler-based embodiments, a spooler receives a print job for despooling and modifies the print job to include a separator page. Before modification, the print job spool data type may be determined. This may be achieved by examination of the spool file contents or by communication with the printer driver.

If the spool data is printer-ready data, such as RAW mode data, the spooler may extract print job characteristics from the printer-ready spool file 10 as shown in FIG. 1. Printer-ready spool file 10 may typically commence with a start job command 12 followed by other commands that define job characteristics. These characteristics may comprise paper size 14, input/output tray selection 16, print order 18 and other characteristics 20-24. Print job characteristics may be specified in Printer Job Language (PJL) or may be specified in a Page Description Language (PDL), such as PCL or Postscript. Whatever the language, the spooler may parse the data to determine print job characteristics. A printer-ready spool file 10 may also comprise print job page data 26 and will typically conclude with an End of job command 28.

Once the spool data file is parsed and characteristics are determined, the spool data may be reconstructed into a combined print job 30 comprising a separator page and original print job data. The combined print job 30 may be constructed by rewriting the spool data to a new file, inserting data into an existing spool data file or by some other logical abstraction. The reconstructed combined print job spool file 30 may comprise a start of job command 32, print job commands to maintain correct paper size 34, output tray information 36 and print order data 38 along with a simplex page command 40 and job separator page data 42. The simplex command 40 may be used to prevent the first page of the print job from printing on the back side of the job separator page.

The combined print job 30 may also comprise commands related to the number of copies, orientation, duplex formatting and others 44-48. Page content data 50 will also be comprised within the combined print job. The combined print job will typically be concluded with an End of job command 52.

The combined print job may be written directly to the port manager(s) associated with the selected printer(s) or may be stored for access by print system components.

In embodiments of the present invention employed in systems that split print jobs between multiple printing devices such as cluster printing embodiments, job separator pages may be generated for each portion of the original print job. Separator pages may comprise additional information that identifies the portion of the print job associated with the separator page and/or total print job information.

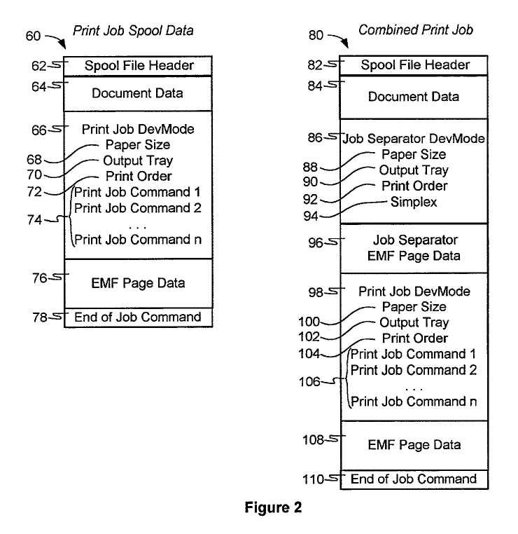

If the spool data is journaled mode data, such as Enhanced Metafile (EMF) data, the spooler may extract print job characteristics from the journaled spool file 60 as shown in FIG. 2. Journaled spool file 60 may commence with a spool file header 62 followed by other commands that may define job characteristics. These characteristics may comprise paper size 68, input/output tray selection 70, print order 72 and other characteristics 74. In a Microsoft EMF mode system, these characteristics may be expressed in DEVMODE. DEVMODE commands may comprise device specific commands and device independent commands. However, generally, in a Microsoft EMF system, job characteristics 68-74 are expressed in device independent commands that require no knowledge of device parameters. A spooler may parse EMF command data to determine print job characteristics. An EMF spool file 60 may also comprise print job page data 76 and will typically conclude with an End of job command 78.

Once the spool data file 60 is parsed and characteristics are determined, the spool data may be reconstructed into a combined print job 80 comprising a separator page and original print job data. The combined print job 80 may be constructed by rewriting the spool data to a new file, inserting data into an existing spool data file or by some other logical abstraction.

The reconstructed combined print job spool file 80 may comprise a spool file header 82, device independent print job commands such as device-independent DEVMODE commands 86 for maintaining correct paper size 88, output tray information 90 and print order data 92 corresponding to the job separator page. This data may be accompanied by a simplex page command 94. The simplex command 94 may be used to prevent the first page of the print job from printing on the back side of the job separator page. The combined print job 80 may also comprise journaled page data 96 representing the data expressed on the separator page.

A combined print job file 80 may further comprise print job commands corresponding to the original print job 98. These commands 98 may be used to maintain correct paper size 100, output tray information 102 and print order data 104 corresponding to the original print job. Other commands 106 may also be used in relation to the number of copies, orientation, duplex formatting and other parameters. Page content data 108 from the original print job will also be comprised within the combined print job. The combined print job will typically be concluded with an End of job command 110.

The combined print job may be written directly to the port manager(s) associated with the selected printer(s) or may be stored for access by print system components.

In embodiments of the present invention employed in journaled data systems that split print jobs between multiple printing devices such as cluster printing embodiments, job separator pages may be generated for each portion of the original print job. Separator pages may comprise additional information that identifies the portion of the print job associated with the separator page and/or total print job information.

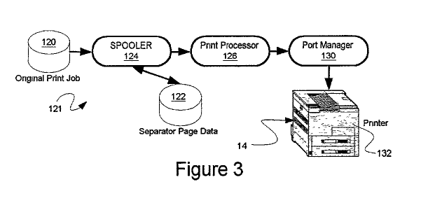

Embodiments of the present invention may create combined print job files 30 & 80 using various print system components. In some embodiments, a combined print job file 30 or 80 may be created with a spooler 124 as shown in FIGS. 3-5. In these embodiments, a print job 120 is sent to spooler 124. Spooler 124 may combine print job 120 with a separator page file 122. This may be performed when print job file 120 is a printer-ready file or when print job 120 is a journaled file, such as an EMF file.

When a print system 121 is operating in printer-ready mode, as shown in FIG. 3, print job 120 will arrive at spooler 124 as a printer-ready print job. Spooler 124 may combine a printer-ready separator page print job 122 with print job 120 to form a printer-ready combined print job 125, which is sent to a print processor 126. Print processor 126 forwards the printer-ready combined print job 125 to a port manager 130 and on to a destination printer 132.

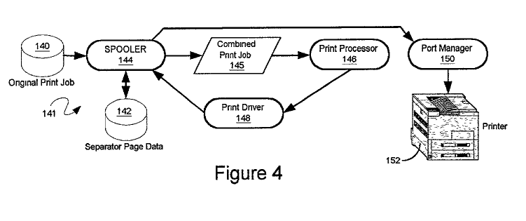

When a print system 141 is operating in a journaled mode, as shown in FIG. 4, print job 140 will arrive at spooler 144 as a journaled print job, such as an EMF print job. In this case, spooler 144 may combine journaled print job 140 with a separator page print job 142 to create a combined journaled print job 145 comprising original print job 140 and separator page data. It should be noted that, in some embodiments, separator page print job 142 may exist only in concept and may be created only as a portion of a combined print job 145. In other embodiments, separator page print job 142 may exist as a distinct file stored on a storage device, in memory or in some other form.

Combined, journaled print job 145 is sent to print processor 146, which determines the journaled status of the print job and directs the job to print driver 148, which, in conjunction with other print system components such as a graphic device interface (GDI), converts the journaled job to a printer-ready print job. The converted, printer-ready job is then sent back to spooler 124 and despooled to port manager 150 and destination printer 152.

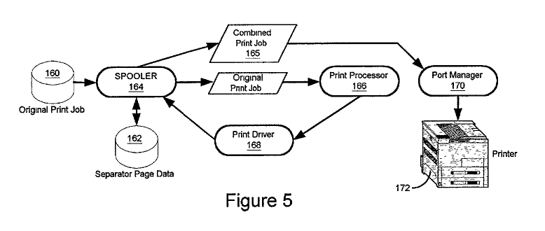

In other embodiments of the present invention operating in journaled mode, as shown in FIG. 5, separator page data may be combined with a print job 160 after conversion to a printer-ready print job. In these embodiments, a journaled print job 160 is sent to spooler 164. Spooler 164 despools the print job 160, without modification, to print processor 166, which directs the print job to a printer driver 168, which, in conjunction with other print system components such as a graphic device interface (GDI), converts the journaled job to a printer-ready print job. This printer-ready print job is sent back to spooler 164 where it is modified and combined with separator page data 162 to form a combined print job 165 comprising the original print job 160 and a separator page.

The combined, printer-ready print job 165 is despooled to a port manager 170 and forwarded to a destination printer 172 where the print job is printed with a job separator page as a single print job.

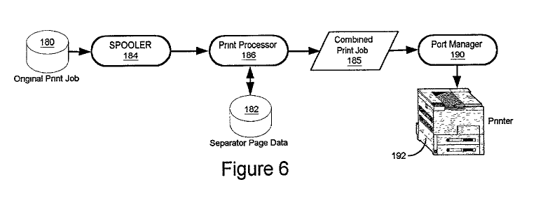

In other embodiments of the present invention, print job separator page data may be combined with a print job by a print processor, as shown in FIGS. 6-8.

Some of these embodiments may operate in a printer-ready mode system as shown in FIG. 6. In these embodiments, a print job 180 is sent to a spooler 184 for despooling to print processor 186. When print job 180 arrives at print processor 186, print job 180 is analyzed to determine print job characteristics. When print job characteristics have been determined, print job separator page data 182 may be generated and combined with original print job 180 to create a combined print job 185, which comprises the original print job 180 along with a job separator page. This combined print job 185 may be sent to a port manager 190 where it may be directed to a destination printer 192 for printing.

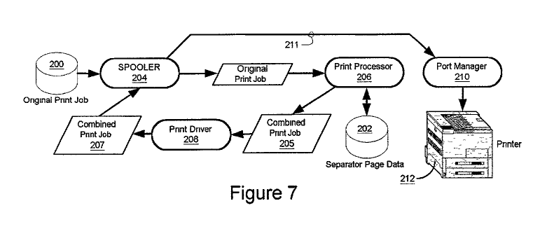

Other embodiments, shown in FIG. 7, may operate in a journaled mode system. In these embodiments, a journaled print job 200, such as an EMF print job, may be sent to a spooler 204 for despooling to a print processor 206. Print processor 206 may analyze print job 200 to determine print job characteristics and compile job separator page data 202 for creation of a job separator page. Print processor 206 may further combine journaled print job 200 with job separator page data 202 to form a single combined print job 205. Journaled, combined print job 205 is then sent to printer driver 208, which, in conjunction with other print system components such as a graphic device interface (GDI), converts journaled, combined print job 205 into a printer-ready format, such as a RAW format file. This printer-ready combined print job 207 is sent to spooler 204 for despooling 211 to a port manager 210 and on to a destination printer 212.

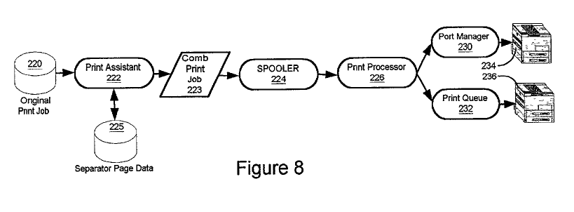

Further embodiments of the present invention may employ a dedicated print system component that is independent of a spooler or print processor, as shown in FIGS. 8-12.

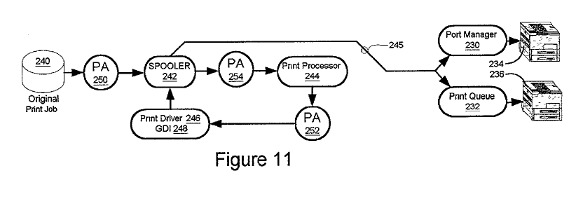

These embodiments may operate in a printer-ready mode system as shown in FIGS. 8-10 or in a journaled mode system as shown in FIGS. 11 & 12.

In embodiments operating in a printer-ready mode system such as those illustrated in FIG. 8, a print job 220 may be sent to a print assistant 222, which may be an independent print system component that is not an integral part of other components such as a spooler 224 or print processor 226. Print assistant 222 may analyze print job 220 to determine its characteristics and compile print job separator page data 225. Print assistant 222 may further combine job separator page data with print job 220 to form a single, combined print job 223 that is sent to a spooler 224 for despooling to print processor 226. Print processor 226 may then send the combined print job to a port manager 230 for transmission to a local printer 234 or to a print queue 232 for transmission to a network printer 236.

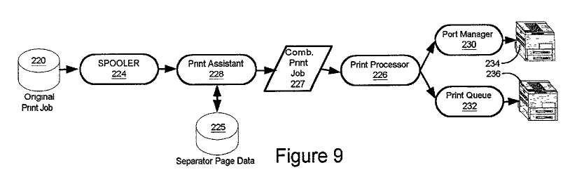

In other embodiments operating in a printer-ready mode system such as those illustrated in FIG. 9, a print job 220 may be sent to a spooler 224 for despooling to a print assistant 228, which may be an independent print system component that is not an integral part of other components such as a spooler 224 or print processor 226. Print assistant 228 may analyze print job 220 to determine its characteristics and compile print job separator page data 225. Print assistant 228 may further combine job separator page data with print job 220 to form a single, combined print job 227 that is sent to a print processor 226. Print processor 226 may then send the combined print job to a port manager 230 for transmission to a local printer 234 or to a print queue 232 for transmission to a network printer 236.

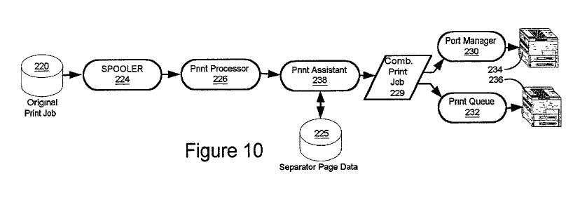

In further embodiments operating in a printer-ready mode system such as those illustrated in FIG. 10, a print job 220 may be sent to a spooler 224 for despooling to a print processor 226. Print processor 226 may send print job 220 to a print assistant 238, which may be an independent print system component that is not an integral part of other components such as a spooler 224 or print processor 226. Print assistant 238 may analyze print job 220 to determine its characteristics and compile print job separator page data 225. Print assistant 238 may further combine job separator page data with print job 220 to form a single, combined print job 229 that is sent to a port manager 230 for transmission to a local printer 234 or to a print queue 232 for transmission to a network printer 236.

Still further embodiments, shown in FIG. 11, may operate in a journaled mode system. In these embodiments, a journaled print job 240, such as an EMF print job, may typically be sent to a spooler 242 for despooling to a print processor 244. Print processor 242 will typically identify the journaled print job and send it to a printer driver 246, which, in conjunction with other print system components such as a graphic device interface (GDI) 248, converts journaled print job into a printer-ready format, such as a RAW format file.

These embodiments, however, differ from this typical system in that a print assistant 250, 252 or 254 may reside at various locations in the print system. Print assistants 250, 252 or 254 may analyze print job 240 to determine print job characteristics and compile job separator page data for creation of a job separator page. Print assistants 250, 252 or 254 may further combine journaled print job 240 with job separator page data to form a single combined print job.

The combined, journaled print job may then be sent to a printer driver 246, which, in conjunction with other print system components such as a graphic device interface (GDI) 248, converts the journaled, combined print job into a printer-ready format. This printer-ready, combined print job is then sent to spooler 242 for despooling 245 to a port manager 230 for transmission to a local printer 234 or to a print queue 232 for transmission to a network printer 236.

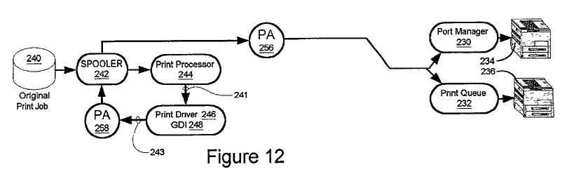

Other embodiments of the present invention may also operate in a journaled mode system, but combine separator page data with the original print job after the original print job is converted to printer-ready data. Some of these embodiments are illustrated in FIG. 12. In these embodiments, an original print job 240 is sent to a spooler 242 for despooling to a print processor 244. Print processor 244 determines that the job is a journaled job and sends the journaled print job 241 to printer driver 246 for processing. Printer driver 246 and associated print system components such as a GDI 248 convert journaled print job 241 into a printer-ready print job 243, which is typically sent back to spooler 242 for despooling to a port manager 230 or print queue 232.

However, in these embodiments, a print assistant 256 or 258 may intercept the printer-ready print job 243. Print assistants 256 or 258 may then analyze the intercepted print job 243 and determine print job characteristics. Print assistants 256 or 258 may also compile print job characteristics into an expression of the characteristics that may be combined with the print job 243 to form a combined, printer-ready print job. This combined printer-ready print job may then be transmitted through the print system as a typical print job.

Any embodiments of the present invention may function within network, remote, local and other print environments. While the embodiments described above may only describe specific environments, each embodiment may be adapted to other print environments not specifically described therewith. For example, embodiments which describe sending a print job to a port monitor for a local printer may also send a print job to a network print queue, a remote printer or some other destination. Likewise, embodiments which describe network print systems may also work with local and remote environments.

It should also be noted that print system components of embodiments of the present invention may be located on a client machine, a print server or on some other part of a print system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for combining a print job separator page with a print job, said method comprising:
receiving an original print job at a print system component;
analyzing said original print job with said print system component; and
creating a combined print job comprising said original print job and a print job separator page.

2. The method of claim 1 wherein said print system component is a print processor.

3. The method of claim 1 wherein said print system component is a spooler.

4. The method of claim 1 wherein said print system component is a print assistant.

5. The method of claim 1 wherein said print system component is located on a print server.

6. The method of claim 1 further comprising s ending said combined print job to a printer.

7. The method of claim 1 further comprising sending said combined print job to a print server.

8. The method of claim 1 wherein said creating comprises adding data for said print job separator page to said original print job.

9. The method of claim 1 wherein said creating comprises creating a new print job file comprising data for said print job separator page and said original print job.

10. The method of claim 1 wherein said combined print job comprises said original print job preceded by a job separator page that identifies said original print job.

11. The method of claim 1 wherein said print job separator page comprises a summary of characteristics of said original print job.

12. A method for combining a print job separator page with a print job, said method comprising:
transmitting an original print job to a print system component;
determining characteristics of said original print job with said print system component;
compiling print job separator page data based on said characteristics; and
creating a combined print job comprising said original print job and a print job separator page;
wherein said print job separator page comprises said print job separator page data based on said characteristics.

13. A method for modifying an original print job, said method comprising:
transmitting an original print job to a print system component;
determining characteristics of said original print job; and
modifying said original print job to add a description of said characteristics to said original print job.

14. A print system component for combining a print job separator page with a print job, said component comprising:
a receiver for receiving a print job;
an analyzer for analyzing said print job; and
a combiner for combining said print job with a print job separator page thereby creating a single combined print job.

15. A computer readable medium comprising instructions for combining a print job separator page with a print job, said instructions comprising the acts of:
receiving an original print job at a print system component;
analyzing said original print job with said print system component; and
creating a combined print job comprising said original print job and a print job separator page.

16. A computer data signal embodied in an electronic transmission, said signal having the function of combining a print job separator page with a print job, said signal comprising instructions for:
receiving an original print job at a print system component;
analyzing said original print job with said print system component; and
creating a combined print job comprising said original print job and a print job separator page.
